(19) United States
(12) Patent Application Publication
(10) Pub. No.: US 2014/0033085 A1
(43) Pub. Date: Jan. 30, 2014

(54) GOAL-ORIENTED USER INTERFACE

(71) Applicants: Joseph Kopetsky, Philadelphia, PA (US); Teri Barrows Sun, San Diego, CA (US); Andrew Chapin, Hoboken, NJ (US); Jodi A. Vautrin, Somerville, MA (US); Karl Von Beckmann, Santa Clara, CA (US); Michael Andrew Davis, Burlington, MA (US); Daniel Jeffrey Greenwald, Burlington, MA (US)

(72) Inventors: Joseph Kopetsky, Philadelphia, PA (US); Teri Barrows Sun, San Diego, CA (US); Andrew Chapin, Hoboken, NJ (US); Jodi A. Vautrin, Somerville, MA (US); Karl Von Beckmann, Santa Clara, CA (US); Michael Andrew Davis, Burlington, MA (US); Daniel Jeffrey Greenwald, Burlington, MA (US)

(21) Appl. No.: 13/557,110

(22) Filed: Jul. 24, 2012

(51) Int. Cl. G06F 3/01

(52) U.S. Cl. 715/763

(57) ABSTRACT

Methods and apparatus, including computer program products, are provided for user interfaces. In one aspect there is provided a method. The method may include receiving a first goal information representative of at least a first goal of a user; receiving a second goal information representative of at least another goal of at least one other user; storing the first goal information and the second goal information; generating, by a page generator, a page including a graphical element representative of a bloom, wherein the bloom corresponds to the first goal of the user; and providing the page to a user interface for presentation. Related systems, methods, and articles of manufacture are also disclosed.

### FIELD

The present disclosure generally relates to data processing.

### BACKGROUND

Today, computer users are inundated with information. So much so that many computer users find it difficult to manage their daily tasks, much less personal goals and aspirations. Although many project management tools are available, these tools are considered by many as ill suited for personal goals, such as learning a language, learning to play an instrument, planning a vacation, and the like.

### SUMMARY

In one aspect there is provided a method. The method may include receiving a first goal information representative of at least a first goal of a user; receiving a second goal information representative of at least another goal of at least one other user; storing the first goal information and the second goal information; generating, by a page generator, a page including a graphical element representative of a bloom, wherein the bloom corresponds to the first goal of the user; and providing the page to a user interface for presentation.

In some implementations, the above-noted aspects may further include additional features described herein including one or more of the following. The generating may further comprise generating the bloom to include a bud coupled via a plurality of filaments to a plurality of seeds. The generating may further comprise generating the bloom to include a bud coupled via a plurality of filaments to a plurality of seeds, at least one of the plurality of seeds representative of the first goal of the user. An indication of a selection of the at least one of the plurality of seeds may be received from a user interface. The page generator may generate another another page including metadata defining one or more aspects of the first goal. At least one other graphical element may be generated, wherein the at least one other graphical element may be selected by a user to present the second goal information representative of the at least another goal of at least one other user.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts an example of a system configured to generate pages which may be presented at user interface in a structured way to allow a user to access, view, and/or modify information, such as goals and the like, in accordance with some exemplary implementations;

FIGS. 2-5 depicts example pages generated by system 100 and presented at user interface 110; and

FIG. 6 depicts an example process, in accordance with some exemplary implementations;

Like labels are used to refer to same or similar items in the drawings.

### DETAILED DESCRIPTION

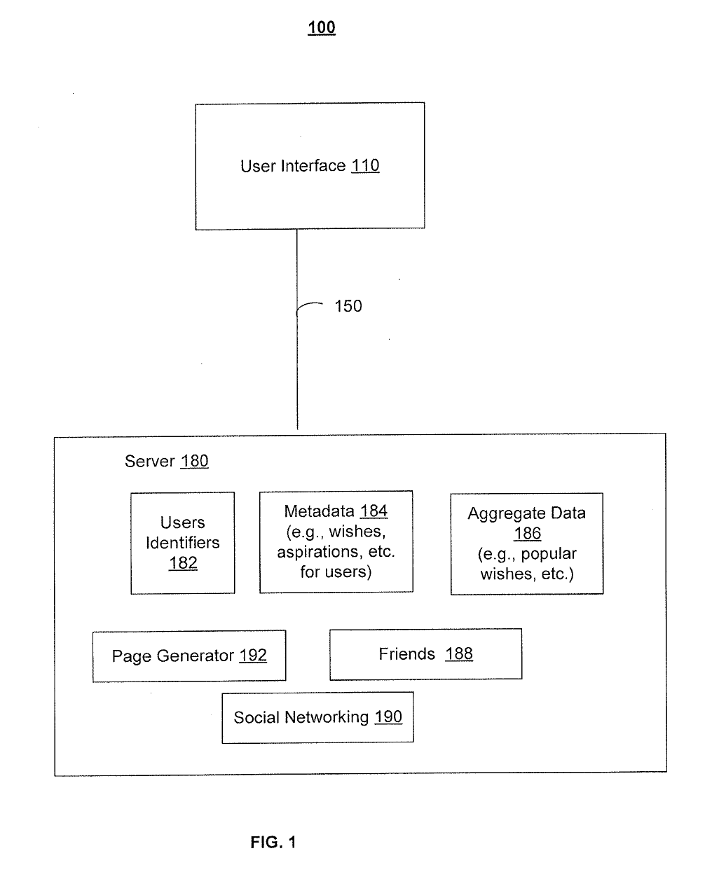

FIG. 1 depicts as system 100 including a user interface 110 coupled via a network 150, such as the Internet and the like, to a server 180, in accordance with some implementations. The server 180 may include user identifiers 182 to identify users registered to use system 100, metadata 184 representative of information, such as goals, associated with the registered users, aggregate data 186 representative of other information which may be of interest to registered users (e.g., other goal-related information, such as similar or related goals made by other users), friends information 188 identifying other users registered at system 100, a social networking interface 190 to allow access to other servers and/or websites, and a page generator 192 to generate pages for presentation.

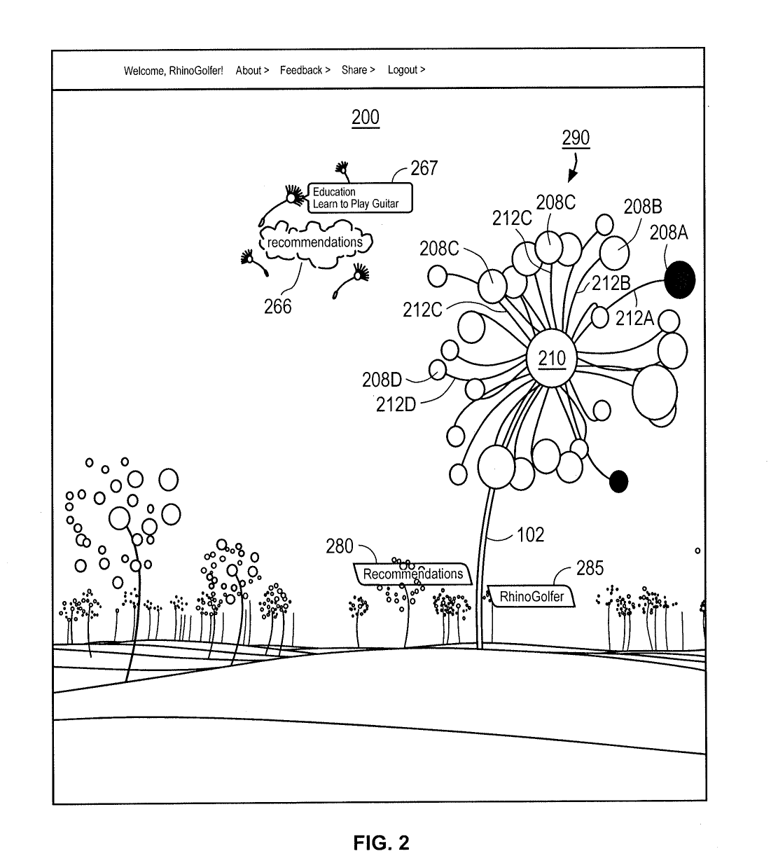

User interface 110 may comprise at least one processor and at least one memory including code which when executed provides one or more applications, such as a browser, a thin client, and the like. The user interface 110 may be configured to present one or more pages (e.g., hypertext markup language pages and the like), and some of the pages may be generated by page generator 192. Examples of pages which may be presented at user interface 110 are shown at FIGS. 2-5.

A user of system 100 may register with system 100, and provide information representative of one or more goals. In some implementations, the user provides information regarding one or more goals via a survey provided by server 180, although the information may be provided in other ways. Once the user provides the goal information to server 180, server 180 processes and stores the goal information, and then page generator 192 generates a page, such as page 200 depicted at FIG. 2.

Before providing additional description regarding system 100, the following provides a description of the pages which may be presented at user interface 110 in a structured way to allow a user to access, view, and/or modify information, such as goals and the like. As used herein, the term “goals” refers to a task, an aspiration, and/or a wish that a user may want to achieve.

Referring to page 200 at FIG. 2, a graphical element 290 is depicted which is referred to herein as a bloom 290. The bloom 290 provides a way to graphically display information, such as a user's goal and data associated with the goal. Bloom 290 may include a graphical element representative of a bud 210 coupled by graphical elements representative of filaments 212A-G to one or more graphical elements representative of seeds 208A-G.

In some implementations, the seeds 208A-G may each represent a goal, such as learn to play golf, climb Mount Everest, learn to play the guitar, earn a degree, and the like. These goals may be provided by the user to the server 180, and then presented at user interface 110 as bloom 290. Moreover, the seeds 208A-G may be configured by the user to be graphically distinctive. For example, different shades, colors, and the like may be used to categorize the goals. In some implementations, different colors are used to categorize goals (e.g., categories, such as travel, education/learning, creative, sharing, relaxation, and the like).

The bloom 210 may also include graphical elements representative of leaves 280 and 285. The leaves may also present goal-related information. In the example of leaves 280 and 285, the leaves present recommendations determined by server 180 (e.g., recommendations determined from other users and stored at aggregate data 186 or recommendations provided programmatically, such as by an administrative user of system 100).

Moreover, the size of the seeds 208A-G may be configured by the user to vary based on a user's priority for achieving the goal, while the length of the filament may represent how close the user is to accomplishing the goal. For example, seed 208G is larger than seed 208F, so in this example, the user has designated the goal corresponding to seed 208G as having a higher priority for completion than seed 208F. However, the filament 212F for seed 208F is longer than the filament 212G for seed 208G, so the user is actually closer to achieving the goal for seed 208F.

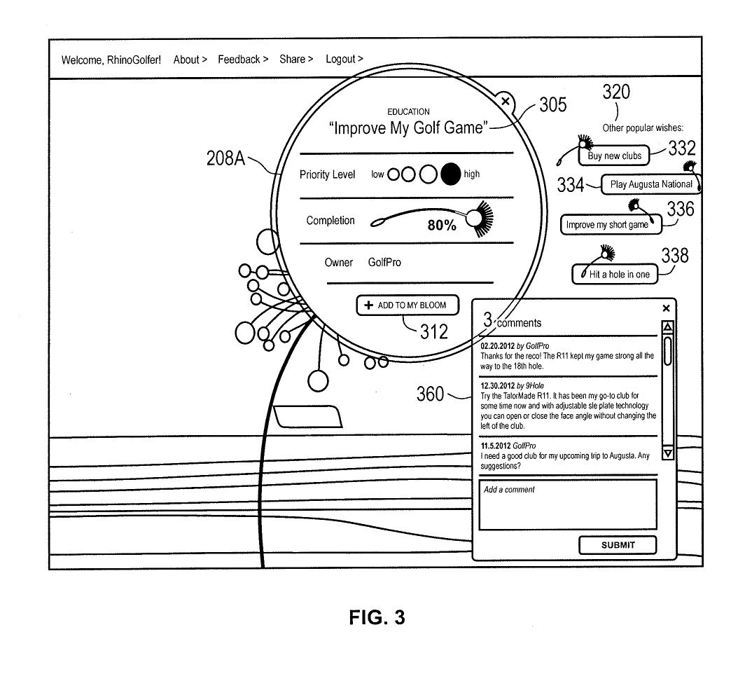

In some exemplary implementations, when a user selects a seed presented on a user interface by for example clicking on the seed, rolling over the seed with a cursor, and the like, additional information is presented for the selected seed, which corresponds to a goal. For example, when seed 208A is selected, user interface 110 may send a message to server 180 to provide additional information regarding the goal corresponding to seed 208A. Server 180 may then retrieve goal information stored at metadata 184 for seed 208, provide the obtained information to page generator 192 to generate a page for presentation at user interface 110. In this example, the seed 208A represents a goal to improve my golf game, an example of which is depicted at FIG. 3.

FIG. 3 depicts a page 300 including an expanded version of seed 208A. Seed 208A represents the goal of “improve my golf game” 305. In this example, the metadata related to the goal, such as priority level 307 to complete the goal, amount of, or percentage of, goal completed 308, and an owner 310 for the goal, may be presented within the expanded seed 208A depicted at page 300. If the goal is a new goal being added to bloom 290, a graphical element, such as add to my bloom 312, may be presented to allow the user to add the seed 208A, although if the seed 208A is already on the bloom 290, a delete from my bloom icon may be presented as well. In some implementations, the seed also includes an icon to share the bloom with other users, such as other users of system 100, a social networking website, and the like.

Page 300 may also present other goals (labeled as popular wishes) 330 to allow the user to view, consider, and/or select these other goals. For example, server 180 may, based on the goal, search for other goals stored at metadata 184. In this example, metadata 184 may include goals from other users or provided programatically, so that a search for golf related goals may generate goals, such as buy new clubs 332, play Augusta 334, improve my short game 336, hit a hole in one 338, and the like. These goals from other users may be presented as graphical elements 332-338 and may each include a textual description of the goal (e.g., buy new clubs 332). The graphical elements may also include a filament and a seed. For example, if a user selects at the user interface wish 332, details regarding the wish may be presented, and the user may be presented with an icon to add the goal to the bloom 290. These goals from other users may assist the user to achieve their own goals.

Page 300 may also include textual comments 360 provided by other users. These textual comments 360 may be obtained from a variety of sources, such as server 180, social networking web sites via social networking interface 190, email, text, and/or directly from a posting at 360, and the like.

Although some of the examples described herein relate to golf related goals, any other types of goals and other types of information may be used as well.

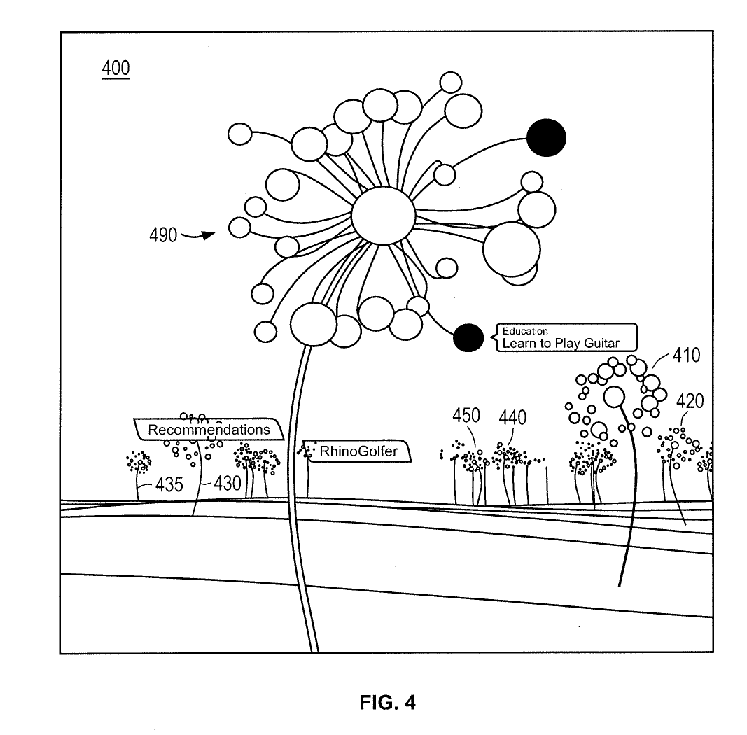

FIG. 4 depicts a page 400 including bloom 490 as well as other blooms 410-450, and so forth. The other blooms 410-450 may be associated with other users which have chosen to share their blooms with others. For example, bloom 410 may correspond to goals of a first user; bloom 420 may correspond to goals of a second user; and bloom 430 may correspond to goals of a third user; and so forth. In this example, a user may browse information from other user by selecting another bloom, such as blooms 410-450, and viewing the information associated with those blooms 410-450 other goals.

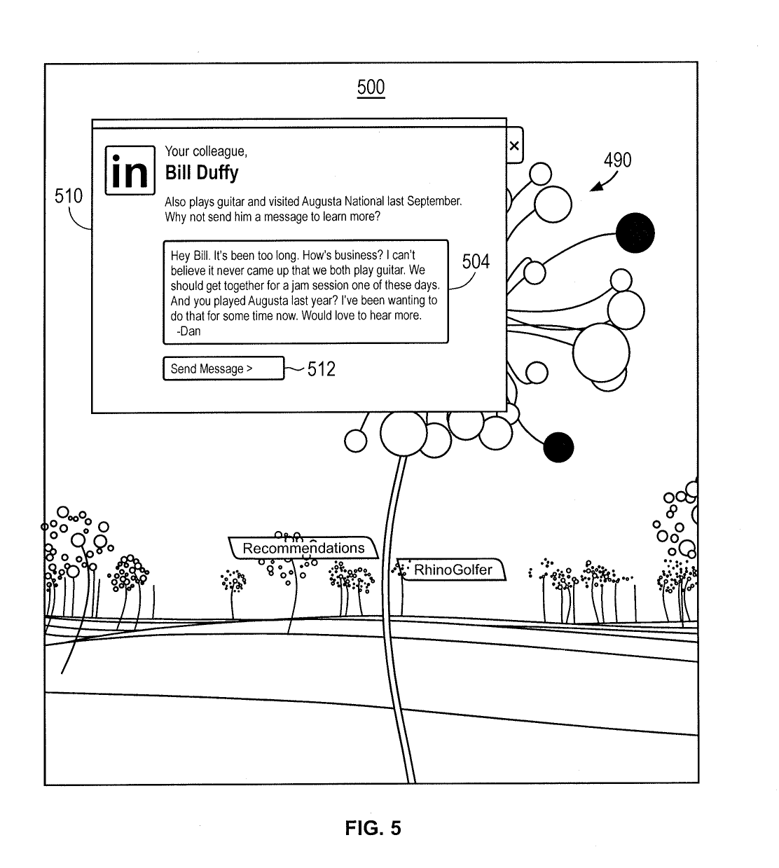

FIG. 5 depicts a page 500 including bloom 490 and a text block 510 provided by server 180 to indicate that a friend also has a similar goal (which in this example is golf) and allows the user to send a message 504 (e.g., a text message, an email, and the like) to the friend by selecting send message 512.

Referring again to FIG. 1, the server 180 may be implemented as at least one processor and at least one memory including code which when executed provides one or more aspects disclosed herein. The description of FIG. 1 also refers to FIGS. 2-6.

In some exemplary implementations, server 180 may be implemented as a website accessible by user via user interface 110, although server 180 may be incorporated into other systems as well (e.g., a social networking website, a business system, a cloud computing-based business system, and the like). In some exemplary implementations, server 180 includes a database containing one or more tables storing the user identifiers 182, metadata 184 (e.g., representative of goals for each registered user), and aggregate data 186 (e.g., popular wishes/goals).

In some exemplary implementations, when a registered user accesses the system, a survey may be presented to the user at user interface 110. The survey may prompt the user to provide information, such as goals (also referred to as aspirations, wishes, and the like), assign categories to goals, define popular wishes, and provide any other information regarding goals (or a configuration for the blooms) for the user. The user may also be asked to create a user name and password (which may be confirmed by system 100 by sending an email to the user's account).

Next, server 180 may create a bloom for the user, such as bloom 290. For example, server 180 may access metadata 184 and aggregate data 186 to provide information to present at bloom 290. The aggregate data 186 may also include suggested goals from other users, which may also be presented as seeds 332-226 or leaves 280 286. The suggested goals (also referred to as wishes) from other users may be specific to a category associated with the goals of bloom 290. For example, if bloom 290 includes a travel goal and a golf goal, server 180 may search aggregate data for related suggested goals from other users and provide them to page generator 192 for presentation at bloom 290.

User identifiers 182 may include, for each user, a user identifier and associated data, such as a password, an email address, privacy settings, social networking sites associated with the user (e.g., where the user or the user's friends are registered), and the like. The user identifiers may be stored as a table of a database, although other types of data storage may be used as well.

Metadata 184 may include one or more goals and associated data. For example, metadata 184 may store a plurality of goals, each of which identifies a user. Moreover, the goals may have associated goal-related information, such as priority to complete the goal, percentage completion, owner, and the like. As such, when a query is made for a given user, metadata provides information for presentation at a bloom, such as bloom 290.

Aggregate data 186 may include other goals provided by other users. In some exemplary implementations, the other goals may be stored as a table. For example, aggregate data 186 may store a plurality of goals provided by users, and these goals are categorized by one or more categories. In this example, a search of aggregate data 186 for a golf related goal, such as learn to play golf, may provide other goals, such as buy golf clubs, take a golf lesson, and the like. Moreover, other category of goals may also be presented, such as travel to Augusta may be identified by the search of aggregate data 186. As such, when a query is made for a given user, metadata provides information for presentation as suggested goals/wishes (e.g., presented as seeds and/or leaves). In some implementations, user identifiers 182, metadata 184, and aggregate data 186 are each stored in a table of a database, although other storage configurations and types may be used as well.

Friends 288 may store friends identified by the user. For example, a registered user may provide an identifier to locate a friend via email address or social networking website. In this example, the friend may receive, provide, and/or view information associated with the user's bloom. Friends may also be registered at system 100 to provide goals and access blooms and the like.

Page generator 192 may receive information from one or more data sources, and configure a bloom, seeds, and the like to allow a user to view goal-based information as a page at user interface 110. The page generator 192 may send the page as an HTML page to user interface 110, although other formats may be used.

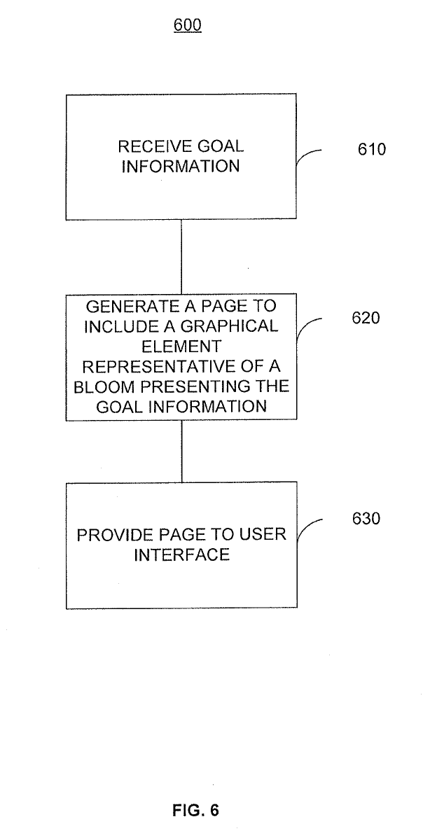

FIG. 6 depicts a process for generating pages which may be presented at user interface in a structured way to allow a user to access, view, and/or modify information, such as goals and the like. The description of FIG. 6 also refers to FIGS. 2-5.

At 610, system 100 may receive goal-related information. This received information may include one or more goals and other goal related information, such as priority, completion, owner, type, and the like. In addition, the received information may include goal information from other users, such as other popular goals. For example, system 100 may receive goal information representative of at least a first goal of a user and store the information at metadata 184 with information identifying the goal information as belong to the user. System 100 may also receive goal information representative of one or more goals of other users as well. The other goal information may be stored at metadata 184 with information identifying the goal information as belong to the other users. Moreover, the other goal information may be stored at aggregate data 186 and categorized to allow retrieval as so-called popular goals or wishes.

At 620, a page may be generated to include a graphical element representative of a bloom presenting the goal related information. For example, page generator 192 may generate a bloom, such as bloom 290, including the information associated with the bloom 290. Referring to FIG. 2, page generator 192 may present the goal of learning to play golf as seed 208A and present other goals as other seeds for the user at seeds 208B-G, and goals from other users may be presented as seeds 266 and 267. Page generator 192 may also provide an expanded seed, such as seed 208A at FIG. 3, when a user selects the seed 208A. Moreover, page generator 192 may also present blooms for other users as noted with respect to FIG. 4.

At 630, the page including the bloom may be sent to user interface 110 for presentation. For example, page generator 192 may send the page including the bloom and other information presented at page 200, 300, 400, and/or 500 to user interface 110 for presentation.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A non-transitory computer-readable medium containing instructions to configure at least one processor to perform operations comprising:
receiving a first goal information representative of at least a first goal of a user;
receiving a second goal information representative of at least another goal of at least one other user;
storing the first goal information and the second goal information;
generating, by a page generator, a page including a graphical element representative of a bloom, wherein the bloom corresponds to the first goal of the user; and
providing the page to a user interface for presentation.

2. The non-transitory computer-readable medium of claim 1, wherein the generating further comprises:
generating the bloom to include a bud coupled via a plurality of filaments to a plurality of seeds.

3. The non-transitory computer-readable medium of claim 1, wherein the generating further comprises:
generating the bloom to include a bud coupled via a plurality of filaments to a plurality of seeds, at least one of the plurality of seeds representative of the first goal of the user.

4. The non-transitory computer-readable medium of claim 3 further comprising:
receiving, from a user interface, an indication of a selection of the at least one of the plurality of seeds.

5. The non-transitory computer-readable medium of claim 1 further comprising:
generating, by the page generator, another page including metadata defining one or more aspects of the first goal.

6. The non-transitory computer-readable medium of claim 1 further comprising:
generating at least one other graphical element, wherein the at least one other graphical element may be selected by a user to present the second goal information representative of the at least another goal of the at least one other user.

7. A method comprising:
receiving a first goal information representative of at least a first goal of a user;
receiving a second goal information representative of at least another goal of at least one other user;
storing the first goal information and the second goal information;
generating, by a page generator, a page including a graphical element representative of a bloom, wherein the bloom corresponds to the first goal of the user; and
providing the page to a user interface for presentation.

8. The method of claim 7, wherein the generating further comprises:
generating the bloom to include a bud coupled via a plurality of filaments to a plurality of seeds.

9. The method of claim 7, wherein the generating further comprises:
generating the bloom to include a bud coupled via a plurality of filaments to a plurality of seeds, at least one of the plurality of seeds representative of the first goal of the user.

10. The method of claim 9 further comprising:
receiving, from a user interface, an indication of a selection of the at least one of the plurality of seeds.

11. The method of claim 7 further comprising:
generating, by the page generator, another page including metadata defining one or more aspects of the first goal.

12. The method of claim 7 further comprising:
generating at least one other graphical element, wherein the at least one other graphical element may be selected by a user to present the second goal information representative of the at least another goal of the at least one other user.

13. A system comprising:
at least one processor; and
at least one memory including code which when executed by the at least one processor provides operations comprising:
receiving a first goal information representative of at least a first goal of a user;
receiving a second goal information representative of at least another goal of at least one other user;
storing the first goal information and the second goal information;
generating, by a page generator, a page including a graphical element representative of a bloom, wherein the bloom corresponds to the first goal of the user; and
providing the page to a user interface for presentation.

14. The system of claim 13, wherein the generating further comprises:
generating the bloom to include a bud coupled via a plurality of filaments to a plurality of seeds.

15. The system of claim 13, wherein the generating further comprises:
generating the bloom to include a bud coupled via a plurality of filaments to a plurality of seeds, at least one of the plurality of seeds representative of the first goal of the user.

16. The system of claim 15 further comprising:
receiving, from a user interface, an indication of a selection of the at least one of the plurality of seeds.

17. The system of claim 13 further comprising:
generating, by the page generator, another page including metadata defining one or more aspects of the first goal.

18. The system of claim 13 further comprising:
generating at least one other graphical element, wherein the at least one other graphical element may be selected by a user to present the second goal information representative of the at least another goal of the at least one other user.
